(19) United States
(12) Patent Application Publication
(10) Pub. No.: US 2008/0025165 A1
(43) Pub. Date: Jan. 31, 2008

(54) OPTICAL DISC DRIVE AND CONTROL METHOD THEREOF

(75) Inventors: Kab Kyun Jeong, Yongin-si (KR); Moon Soo Han, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/745,584

(22) Filed: May 8, 2007

(30) Foreign Application Priority Data
Jul. 25, 2006 (KR) 2006-70022

(51) Int. Cl. G11B 7/00

(52) U.S. Cl. 369/44.28

(57) ABSTRACT

An optical disc drive and a control method thereof perform a stable layer jump in a deflected optical disc having surface vibration component to increase a rate of success of the layer jump. Accordingly, recording and reproducing of information between layers are continuously performed. The control method of an optical disc drive includes rotating an optical disc, detecting a point where an optical axial relative movement between the optical disc and a pickup module is zero or about zero, and controlling the pickup module such that a layer jump is performed in the vicinity of a point where the optical axial relative speed or movement between the optical disc and the pickup module is zero or about zero during the rotation of the optical disc.

### CROSS-REFERENCE TO RELATED APPLICATION

This application claims the benefit of Korean Application No. 2006-70022, filed on Jul. 25, 2006 in the Korean Intellectual Property Office, the disclosure of which is incorporated herein by reference.

### BACKGROUND OF THE INVENTION

1. Field of the Invention

Aspects of the present invention relate to an optical disc drive and a control method thereof, and more particularly, to a focus jump (layer jump) control between layers on an optical disc having a plurality of recording layers.

2. Description of the Related Art

A disc drive is a device to project a laser beam (referred to as a laser) on a spiral track formed on a recording layer surface of an optical disc to record, reproduce, and erase information. The recording of information is performed by generating a pit in the recording track, and the reproduction of information is performed by projecting a laser on the track formed with the pits and analyzing variation of the quantity of light from the laser that is reflected off of the recording layers with the recording pits. The laser projected from a semiconductor laser diode is focused on the recording track by the operation of optical components such as an objective lens, a prism, and the like, which are arranged in the light path. The optical components generate a light spot of a diameter less than a few micrometers (μm). In order to record and reproduce information to/from the optical disc, the light spot must be continuously formed on the very narrow recording track.

However, since the optical disc has a bend of about 200μm on the optical disc surface and about 50μm of track deflection, the track moves by a large amplitude as the optical disc rotates. Due to these reasons, in order to focus the light spot on a target track and to track the recording track, the objective lens must be controlled using two servo-controls, including a focus servo-control and a tracking servo-control.

The focus servo-control controls the objective lens to move in the normal direction with respect to the surface of the optical disc such that a predetermined sized light spot is formed on the track of the optical disc. Accordingly, the size of the light spot is controlled. On the other hand, the tracking servo-control controls the objective lens to move in the radial direction with respect to the surface of the optical disc such that the light spot is formed along the center of the track. Accordingly, the position of the light spot is controlled.

An apparatus referred to as an optical pickup or a pickup module includes optical components containing the above two actuators to drive the objective lens, a sensor to detect the position of the light spot, a carriage to load the optical components, and a linear actuator to drive the carriage in the radial direction of the optical disc. An optical disc drive includes the pickup module, a digital signal processor, a servo-controller, and a motor.

There are several types of mass memory media, such as the optical discs, in which information is recorded, reproduced, and erased by the same optical disc drive. Two of them are an optical disc (a single layer optical disc) having a single recording layer and an optical disc (a multi-layer optical disc) having two or more recording layers. The multi-layer optical disc is a medium in which two or more recording layers are formed in a single optical disc to increase a recording capacity of the optical disc. Nowadays, as one of the optical discs that are widely used, there is a dual layer optical disc having two recording layers. Different types of the dual layer optical disc include a single-sided dual layer optical disc and a double-sided dual layer optical disc. In the single-sided dual layer optical disc, both of the two layers have a reflecting surface formed in one side of the disc so that the laser is projected onto only one side of the disc. On the other hand, in the double sided dual layer optical disc, reflecting surfaces of respective layers are formed at opposite sides of the disc so that the laser is projected onto both sides of the optical disc.

During recording, reproducing, and/or erasing of the two layers of the multi-layer optical disc, once the recording, reproducing, and/or the erasing of the information on one layer is finished, a layer jump is performed subsequently to move the focus of the pickup module to another layer. However, if the layer jump fails during reproducing of multimedia contents, such as an image, an audio content, or the like, the reproduction of the multimedia contents, which requires continuity, is interrupted. Accordingly, the image or the audio content is not smoothly outputted. Thus, it is important to reduce the failure of the layer jump in the multi-layer optical disc.

There are several reasons for the failure of the layer jump. One of them is caused by the deflection of the optical disc. The deflection of the optical disc is caused by unevenness of the surfaces thereof due to the bending of the optical disc. Since surface vibration is generated in the normal direction of the surfaces during rotation of the deflected optical disc, it is difficult to perform the focus servo-control of the deflected optical disc.

### SUMMARY OF THE INVENTION

Aspects of the present invention include an optical disc drive to steadily perform layer jump on a deflected optical disc having surface vibration to increase a rate of success of the layer jump and a control method thereof.

According to another aspect of the present invention, an optical disc drive steadily performs layer jump on a deflected optical disc to continuously record and reproduce information between layers to increase a rate of uninterrupted recording and reproducing of information and a control method thereof.

In accordance with aspects of the present invention, a control method of an optical disc drive includes a pickup module to perform recording and/or reproducing and/or erasing of information by projecting a laser beam on a surface of respective layers of an optical disc having plural layers; and a servo-controller to generate a focus driving signal for the focus servo-control of the pickup module, the method including: rotating the optical disc; detecting a point relative to the optical disc where a relative movement in an optical axial direction between the optical disc and the pickup module is zero or about zero; and controlling the pickup module to perform a layer jump in the vicinity of the detected point during the rotation of the optical disc.

The detecting the point where the relative movement is zero or about zero includes detecting an envelope of the focus driving signal for the focus servo-control of the pickup module, and determining points where the envelope detection signal is about a maximum value or about a minimum value as the points where the relative speed is zero or about zero.

The control method further includes determining whether the optical disc is deflected or not, wherein when the optical disc is deflected, the pickup module is controlled to perform the layer jump in the vicinity of the point where the relative movement is zero or about zero.

In the determining whether the optical disc is deflected or not, it is determined that the optical disc is deflected when a difference between absolute values of the maximum value and the minimum value of the envelope detection signal exceeds a predetermined value.

The maximum value and the minimum value of the envelope detection signal are detected during one revolution of the optical disc.

The one revolution of the optical disc is determined by detecting a pulse signal generated every one revolution of a spindle motor in rotating the optical disc.

The pickup module is controlled such that the layer jump is performed in a region between two points corresponding to a value that is less than the maximum value of the envelope detection signal by a predetermined value.

The pickup module is controlled such that the layer jump is performed at a region between two points corresponding to a value that is greater than the minimum value of the envelope detection signal by a predetermined value.

The control method further includes detecting a point where the relative movement is zero or about zero for a predetermined time period, and performing the layer jump by a layer jump method without taking the deflection of the optical disc into consideration when the detection of the point where the relative speed is zero or about zero is not detected during the predetermined time period.

The layer jump is performed by taking a deflection of the optical disc into consideration. The detecting of the point where the relative distance is zero or about zero occurs over a predetermine time and so the point is detected when relative speed between the optical disc and the pickup module is zero or about zero. Prior to the controlling of the pickup module to perform the layer jump, a tracking servo-control is stopped and only the focus servo-control is performed.

In accordance with another aspect, the present invention includes a control method of an optical disc drive including a pickup module to perform recording and/or reproducing and/or erasing of information by projecting a laser beam on a surface of respective layers of an optical disc having plural layers; and a servo-controller to generate a focus driving signal for the focus servo-control of the pickup module, the method including: rotating the optical disc; detecting at least one of points relative to the optical disc where optical axial distance between the optical disc and the pickup module is at a maximum or a minimum; and controlling the pickup module such that a layer jump is performed in the vicinity of at least one of the points during the rotation of the optical disc.

The detecting of the at least one of the points where the optical axial distance between the optical disc and the pickup module is at a maximum or a minimum, includes detecting an envelope of the focus driving signal for the focus servo-control of the pickup module, and determining points where the envelope detection signal is a maximum value or a minimum value as a point where the distance is the maximum or where the distance is the minimum.

The control method further includes determining whether the optical disc is deflected or not, wherein when the optical disc is deflected, the pickup module is controlled to perform the layer jump in the vicinity of the at least one of the points where the distance is the maximum or the minimum.

In the determining of whether the optical disc is deflected or not, the optical disc is determined as deflected when a difference between absolute values of the maximum value and the minimum value of the envelope detection signal exceeds a predetermined value.

The maximum value and the minimum value of the envelope detection signal are detected during one revolution of the optical disc.

The one revolution of the optical disc is determined by detecting a pulse signal generated every one revolution of a spindle motor in rotating the optical disc.

The pickup module is controlled such that the layer jump is performed at a region between two points corresponding to a value that is less than the maximum value of the envelope detection signal by a predetermined value.

The pickup module is controlled such that the layer jump is performed at a region between two points corresponding to a value that is greater than the minimum value of the envelope detection signal by a predetermined value.

The control method further includes detecting at least one of the points relative to the optical disc where the distance is maximum or minimum for a predetermined time period, and performing the layer jump without taking the deflection of the optical disc into consideration when the at least one of the points where the distance is the maximum or the minimum is not detected during the predetermined time period.

The layer jump is performed by taking a deflection of the optical disc into consideration.

In accordance with another aspect of the present invention, an optical disc drive includes: a pickup module to perform recording and/or reproducing and/or erasing of information by projecting a laser beam on a surface of respective layers of an optical disc having plural layers; and a servo-controller to control the pickup module such that a layer jump is performed in a vicinity of any point where an optical axial relative movement between the optical disc and the pickup module is zero or about zero during a rotation of the optical disc.

The servo-controller detects an envelope of a focus driving signal of a focus servo-control of the pickup module, and controls the pickup module to perform the layer jump at the any point in the vicinity of the maximum value or the minimum value of the detected envelope detection signal.

The layer jump is performed by taking a deflection of the optical disc into consideration.

In accordance with another aspect of the present invention, an optical disc drive includes: a pickup module to perform recording and/or reproducing and/or erasing of information by projecting a laser beam on a surface of respective layers of an optical disc having plural layers; and a servo-controller to control the pickup module such that a layer jump is performed in the vicinity of any one point of the points where an optical axial distance between the optical disc and the pickup module is a maximum or a minimum during a rotation of the optical disc.

The servo-controller detects an envelope of a focus driving signal for a focus servo-control of the pickup module, and controls the pickup module to perform the layer jump at any point in the vicinity of the maximum value or the minimum value of the detected envelope detection signal.

The servo-controller performs the layer jump by taking a deflection of the optical disc into consideration.

According to aspects of the present invention, a control method of an optical disc drive includes a pickup module to perform recording and/or reproducing and/or erasing of information by projecting a laser beam on a surface of respective layers of an optical disc having a plurality of layers; and a servo-controller to generate a focus driving signal for the focus servo-control of the pickup module, the method includes: rotating the optical disc; detecting whether the optical disc is deflected when a value of an envelope detection signal of the focus driving signal is greater than or equal to |MAX|−|MIN|, where |MAX| is an absolute maximum value of the envelope detection signal and the |MIN| is an absolute minimum value of the envelope detection signal; and controlling the pickup module to perform a layer jump during the rotation of the optical disc when the envelope detection signal is at or between a first predetermined value and the MAX, or at or between a second predetermined value and the MIN.

The envelope detection signal is a low pass filtered signal of the focus driving signal. The envelope detection signal is at or between a first predetermined value and the MAX, or at or between a second predetermined value and the MIN when the relative movement of the pickup module and the optical disc to each other in the optical axis direction is zero or about zero. The layer jump is performed in a margin between the first predetermined value and the MAX, or a margin between the second predetermined value and the MIN.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 is a view illustrating an external appearance of an optical disc of an aspect of the present invention;

FIG. 2 is a sectional view of the optical disc in FIG. 1;

FIG. 3 is a block diagram illustrating an optical disc drive according to an aspect of the present invention;

FIG. 4 is a view illustrating waveforms of control signals of the optical disc drive according to aspects of the present invention; and

FIG. 5 is a flowchart illustrating a control method of the optical disc drive according to an aspect of the present invention.

### DETAILED DESCRIPTION OF THE EMBODIMENTS

Reference will now be made in detail to the aspects of the present invention, examples of which are illustrated in the accompanying drawings, wherein like reference numerals refer to like elements throughout. The aspects are described below to explain the present invention by referring to the figures.

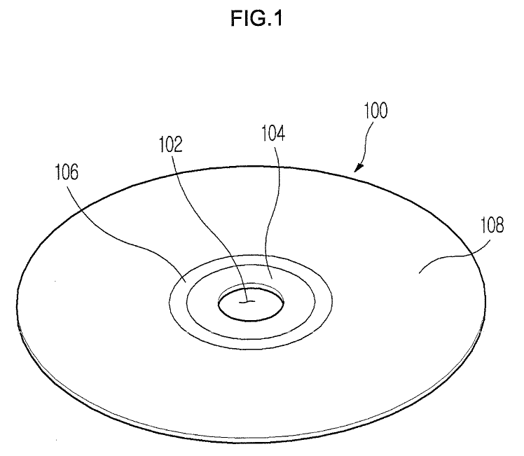

FIG. 1 is a view illustrating an external appearance of an optical disc of an aspect of the present invention. As shown in FIG. 1, a multi-layer optical disc 100 having a plurality of layers with recorded information has a clamping hole 102 into which a rotation shaft is inserted to rotate the optical disc 100. Around the clamping hole 102, a clamping portion 104 is provided to prevent the optical disc 100 from unwanted movement. Around the clamping portion 104, a power calibration area (PCA) 106 and an information area 108 are sequentially formed from the inner side to the outer side in the radial direction of the optical disc 100. In various aspects, information may be recorded as pits or as changed characteristics of the layers.

The PCA 106 is a test area to optimize a power of a laser projected on the information recording surface of the optical disc 100 during the recording and/or reproducing and/or erasing of the information. The PCA 106 is reduced whenever power calibration is performed and the number of calibrations is recorded and counted.

The information area 108 is an area on which desired information to be stored is recorded, and is provided with a lead-in area, an information area, and a lead-out area, which are sequentially formed along a radial direction of the optical disc 100. When a multi-session function enabled recording apparatus and an optical disc are used, the information area 108 will include a number of a group of “lead-in area-information area-lead-out area” in proportion to the number of the multi-sessions.

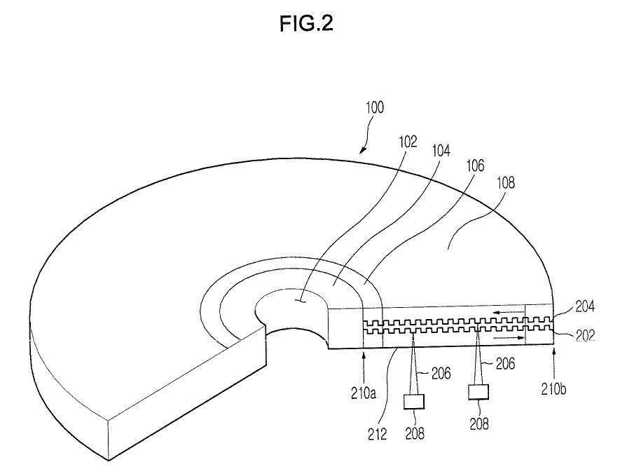

FIG. 2 is a sectional view of the optical disc in FIG. 1. As shown in FIG. 2, the optical disc 100 of an aspect of the present invention has two layers 202 and 204 on which information is recorded. In a dual layer optical disc having two layers, a layer located at a lower side (closer to a laser source) is indicated as a layer 0 (zero) and a layer located at an upper side (farther from a laser source) is indicated as a layer 1 (204). On a surface of the layer 0 202 located at the lower side, a protective layer (shown but not numbered) is formed to protect the layer 0 202 from external shock. The surface of the protective layer directly becomes the surface 212 of the optical disc 100.

In the respective two layers 202 and 204 of the optical disc 100, continuous spiral tracks are formed on which information is recorded, and a pickup module 208 travels from an inner circumference 210a of the optical disc 100 to an outer circumference 210b thereof and vice versa. Also, a beam of a laser is projected on a target track of the two layers 202 and 204 for the recording and/or reproducing and/or erasing of information.

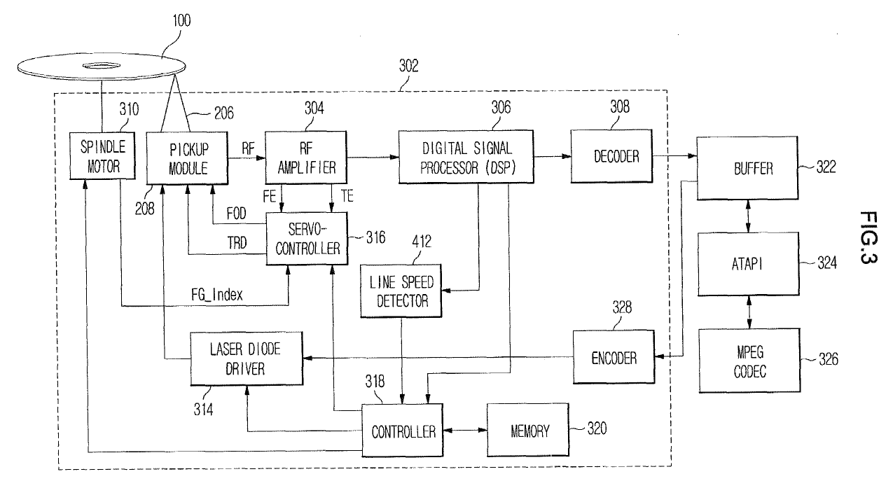

FIG. 3 is a block diagram illustrating an optical disc drive according to an aspect of the present invention. A block indicated by a reference numeral 302 in FIG. 3 is an optical disc drive. Also shown are a buffer 322, an advanced technology attachment packet interface (ATAPI) 324 and an MPEG CODEC 326 as components of another device such as a DVD player or a computer connected to the optical disc drive 302. If necessary, the buffer 322, the ATAPI 324, and the MPEG CODEC 326 may be integrated into the optical disc drive 302. The ATAPI is one of typical data communication interfaces used in communication between an optical disc drive and a CODEC chip. In other aspects, other data communication interfaces are also usable.

As shown in FIG. 3, the optical disc 100 is rotated by a spindle motor 310. The spindle motor 310 is controlled to rotate the optical disc 100 by a driving signal generated by a controller 318. During the rotation, the spindle motor 310 generates a pulse signal FG_Index for every one revolution. Accordingly, a servo-controller 316 detects the pulse signal FG_Index generated by the spindle motor 310 and confirms the number of revolutions of the spindle motor 310.

The pickup module 208 has a laser diode, and projects a laser beam on the recording surface of the optical disc 100. The laser beam is projected with power sufficient or required to record and/or reproduce and/or erase information using the laser diode such that information is recorded and/or reproduced and/or erased on/from the optical disc 100. Moreover, the pickup module 208 includes a photodiode (not shown) as a light receiving component. The photodiode receives the laser 206 reflected from the recording surface of the optical disc 100 to generate an RF signal.

When recording information on the optical disc 100, information is encoded by an encoder 328 and is provided to a laser diode driver 314. The controller 318 provides a driving signal to the laser diode driver 314 to cause the encoded information to be recorded in the information recording surface of the optical disc 100. Accordingly, the controller 318 causes the recording power of the laser diode to be changed.

When reproducing information recorded in the optical disc 100, the controller 318 controls the laser diode of the pickup module 208 to generate a laser beam of power sufficient or required to reproduce information and to project the laser beam on the information recording surface (202 and/or 204) of the optical disc 100. The photodiode (not shown) receives the beam of the laser 206 that reflects off of the recording surface of the optical disc 100 and generates a corresponding RF signal. An RF amplifier 304 receives and amplifies the RF signal generated by the photodiode and converts the same into a binary signal. The binary signal converted by the RF amplifier 304 is restored into digital data by a digital signal processor 306. The restored digital data is encoded. Accordingly, the encoded restored digital data is decoded into original digital data by a decoder 308. The digital signal processor 306 estimates a beta value β, a gamma value y, a peak value, a bottom value, and a mean value, and provides the same to the controller 318. A line speed detector 412 detects a line speed of the optical disc 100 and provides the same to the controller 318.

The RF amplifier 304 extracts a tracking error signal TE and a focus error signal FE from the received RF signal and provides the same to the servo-controller 316. The focus error signal FE extracted by the RF amplifier 304 is a signal corresponding to a focus state of the laser 206 on the surface 212 of the optical disc 100 and the respective layers 202 and 204 based on the RF signal generated by the photodiode. The servo-controller 316 generates a focus driving signal FOD and a tracking driving signal TRD based on the corresponding focus error signal FE and the tracking error signal TE to perform a focus servo-control and a tracking servo-control of the pickup module 208.

The controller 318 manages overall control of the optical disc drive 302, and is connected to an external memory 320 in which information needed to control overall operation of the optical disc drive 302 and data generated during the control are stored.

In a control method of an optical disc drive according to an aspect of the present invention, a degree (amount) of deflection of the optical disc 100 is detected or determined, and when the detected or determined deflection is greater than a predetermined degree (amount), the optical disc 100 is determined as a deflected disc and a layer jump is performed through a layer jump control method of a deflected optical disc 100 according to aspects of the present invention. If the detected or determined deflection degree of the optical disc 100 is less than the predetermined degree, the layer jump is performed by a layer jump control method without taking the deflection into consideration.

During the rotation of the optical disc 100, the surface vibration is generated on the optical disc 100 along the optical axis of the laser 206 due to the deflection. The surface vibration refers to vibration caused by the surface 212 of the optical disc 100 and the pickup module 208 repeatedly approaching each other and then moving away from each other along the optical axis (e.g., wobbling of the optical disc 100 due to bends or deflections). Due to the surface vibration in the optical axis, during the one revolution of the optical disc 100, there exists a point on the surface of the optical disc 100 where the pickup module 208 approaches extremely close to the optical disc 100 (or where the distance between the optical disc 100 and the pickup module 208 is closest), and a point where the pickup module 208 is most distant to the optical disc 100 (or where the distance between the optical disc 100 and the pickup module 208 is furthest).

When the optical axial distance between the surface 212 of the optical disc 100 and the pickup module 208 is decreasing or increasing during a time period, a relative speed (i.e., a change in distance over a change in time) between the surface 212 of the optical disc 100 and the pickup module 208 is very fast. However, at the points where the optical disc 100 and the pickup module 208 are the closest and/or where the optical disc 100 and the pickup module 208 are the furthest, along the optical axis, the relative speed (or the relative distance) of the optical disc 100 and the pickup module 208 is 0 (zero) or about zero. In other words, the relative movement of the optical disc 100 and the pickup module 208 with respect to each other is zero or about zero at those times. In various aspects, during the rotation of the optical disc 100, the layer jump is performed at the point where the relative speed along the optical axis or the relative displacement of the optical disc 100 and the pickup module 208 is zero or about zero.

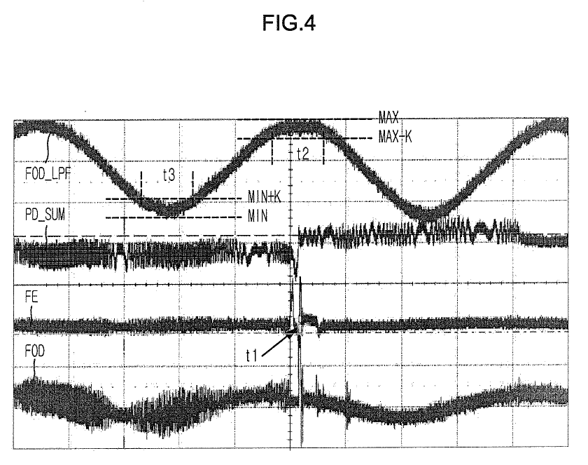

FIG. 4 is a view illustrating waveforms of control signals of the optical disc drive according to aspects of the present invention. As illustrated in FIG. 4, the FOD signal is the focus driving signal, the FE signal is the focus error signal, a PD_SUM signal is a sum of output signals of the photodiode, and an FOD_LPF signal is an envelope detection signal of the focus driving signal FOD, namely, a low pass filtered signal of the focus driving signal FOD.

As illustrated in FIG. 4, a point ti where the layer jump is performed is in the vicinity of a point where the envelope detection signal FOD_LPF becomes a maximum value MAX. Also shown is a region t2 between two points where the maximum value MAX of the envelope detection signal FOD_LPF is subtracted by a predetermined value k (i.e., MAX−k). The layer jump is performed at the region t2. The reason that the layer jump is not performed at the point of the maximum value MAX of the envelope detection signal FOD_LPF, but at some region with a margin, is to increase a rate of success of the layer jump by providing some margin to perform the layer jump instead of providing a restricted condition without any room to make a successful layer jump when determining a point where the layer jump is to be performed.

Referring again to FIG. 4, the layer jump may be performed at a region t3 between two points where a minimum value MIN of the envelope detection signal FOD_LPF is added by the predetermined value k (i.e., MIN+k). In this case, in determining the point where the layer jump is to be performed, it is preferred, but not required, that some margin is provided to increase the rate of success of the layer jump.

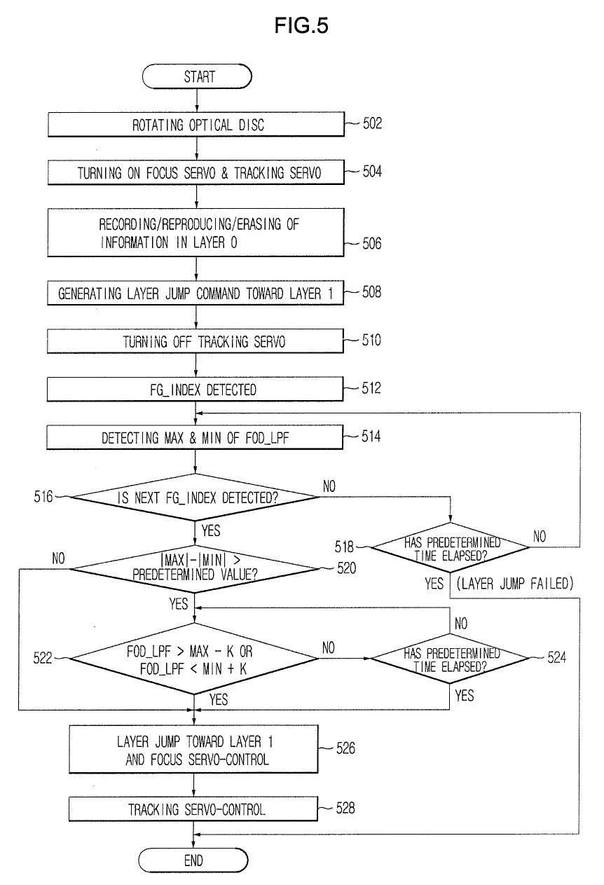

FIG. 5 is a flowchart illustrating a control method of the optical disc drive according to another aspect of the present invention, and which illustrates a layer jump control method of a multi-layer optical disc having at least two layers. As shown in FIG. 5, when the optical disc 100 is loaded in the optical disc drive 302, the spindle motor 310 is driven to rotate the optical disc 100 (operation 502). When the optical disc 100 rotates at a predetermined speed or faster, the focus servo-control and the tracking servo-control are performed for the optical disc 100 such that the laser 206 is focused along the track formed in the layer 0 202 of the optical disc 100 (operation 504). When the focus servo-control and the tracking servo-control are stable, the recording and/or reproducing and/or erasing of the information in the layer 0 202 are performed (operation 506).

When the recording and/or reproducing and/or erasing of the information in the layer 0 202 is finished or the layer jump toward the layer 1 204 is required, the controller 318 generates a layer jump command to the servo-controller 316 (operation 508). When the layer jump command is generated, the servo-controller 316 stops the tracking servo-control and performs only the focus servo-control (operation 510).

Prior to the performance of the layer jump, in order to determine a degree (amount) of deflection of the optical disc 100, the pulse signal FG_Index shown in FIG. 3 is generated during each rotation of the spindle motor 310 (operation 512). When the generated pulse signal FG_Index is detected, detection of the maximum value MAX and the minimum value MIN of the envelope detection signal FOD_LPF of the focus driving signal FOD is performed (operation 514). The detection of the maximum value MAX and the minimum value MIN of the envelope detection signal FOD_LPF is performed until a next pulse signal FG_Index is detected (operation 516). In other words, since the sequentially detected two pulse signals FG_Index refers to one revolution of the spindle motor 310, the sequentially detected two pulse signals FG_Index indicates exactly one revolution of the optical disc 100. Thus, the maximum value MAX and the minimum value MIN of the envelope detection signal FOD_LPF are detected during the one revolution of the optical disc 100 so that the degree of deflection of the optical disc 100 can be determined.

If a difference between absolute values of the maximum value MAX and the minimum value MIN (i.e., |MAX|−|MIN|) of the envelope detection signal FOD_LPF is equal to and/or less than a predetermined value, it is determined that the optical disc 100 is not deflected and the layer jump is immediately performed to the layer 1 204 (‘NO’ in operation 520). On the other hand, when the difference between the absolute values (i.e., |MAX|−|MIN|) is equal to and/or exceeds the predetermined value, it is determined that the optical disc 100 is deflected (‘YES’ in operation 520). In other aspects, the deflection may be detected by other methods.

Meanwhile, during the FG_Index detection operation in operation 516, if the two sequential pulse signals FG_Index are not detected (no in operation 516) and a predetermined time period lapses, then detection is considered as having failed. Accordingly, it is determined that the layer jump has failed and the layer jump control is finished (‘YES’ in operation 518). However, if the two sequential pulse signals FG_Index are not detected (no in operation 516), but the predetermined time period has not lapsed (no in operation 518), the operation proceeds to operation 514).

As shown in FIG. 5, when it is determined that the optical disc 100 is deflected (yes in operation 520), a specific point of the envelope detection signal FOD_LPF is searched and the layer jump is performed at the detected searched point. Operation 522 in FIG. 5 refers to a process of detecting any one point among a point FOD_LPF>MAX−K near the maximum value of the envelope detection signal FOD_LPF, and a point FOD_LPF<MIN+K near the minimum value of the envelope detection signal FOD_LPF that are points to perform the layer jump in the optical disc 100. The points near the maximum value MAX and the minimum value MIN of the envelope detection signal FOD_LPF have been described above with reference to FIG. 4.

As shown in FIG. 5, if the specific points of the envelope detection signal FOD_LPF are found (yes in operation 522), the layer jump towards layer 1 is performed. After jumping from the layer 0 202 to the layer 1 204, the focus servo control is performed for the layer 1 204 of the optical disc 100 by the servo-controller 316 (operation 526). If the points are not found (no in operation 522), and if the search for the points to perform the layer jump is unsuccessful over a predetermined time period, the layer jump is attempted at any point (‘YES’ in operation 524). When the focus servo-control is stable, the tracking servo-control is performed such that the light spot of the laser 206 travels along the track formed in the recording surface of the layer 1 204 to record and/or reproduce and/or erase information (operation 528).

In various aspects, the MAX and/or MIN values of the envelope detection signal FOD_LPF may be previously recorded and/or stored, may be a predetermined value, or a value detected just prior to performing the layer jump. In various aspects, the optical disc may be a compact disc (CD), a digital versatile disc (DVD), a blu-ray disc (BD), a high definition DVD (HD-DVD), or any other medium from which data may be recorded, reproduced, erased, or any combinations thereof.

According to aspects of the present invention, the layer jump is stably or reliably performed for the optical disc having the surface vibration component so that the rate of success of the layer jump is increased and the recording and/or reproducing of information between the layers is continuously performed, thereby increasing the rate of uninterrupted recording and reproducing of information.

Although a few aspects of the present invention have been shown and described, it would be appreciated by those skilled in the art that changes may be made in the aspects without departing from the principles and spirit of the invention, the scope of which is defined in the claims and their equivalents.

What is claimed is:

1. A control method of an optical disc drive comprising a pickup module to perform recording and/or reproducing and/or erasing of information by projecting a laser beam on a surface of respective layers of an optical disc having a plurality of layers; and a servo-controller to generate a focus driving signal for the focus servo-control of the pickup module, the method comprising:
rotating the optical disc;
detecting a point relative to the optical disc where a relative movement in an optical axial direction between the optical disc and the pickup module is zero or about zero; and
controlling the pickup module to perform a layer jump in a vicinity of the detected point during the rotation of the optical disc.

2. The control method of an optical disc drive according to claim 1, wherein the detecting of the point where the relative movement is at or about zero comprises:
detecting an envelope of the focus driving signal for the focus servo-control of the pickup module; and
determining one of the points where the envelope detection signal is about a maximum value or a minimum value as the points where the relative movement is zero or about zero.

3. The control method of an optical disc drive according to claim 2, further comprising determining whether the optical disc is deflected; wherein
when the optical disc is determined as deflected, the pickup module is controlled to perform the layer jump in the vicinity of the point where the relative movement is zero or about zero.

4. The control method of an optical disc drive according to claim 3, wherein in the determining of whether the optical disc is deflected, the optical disc is determined as deflected when a difference between absolute values of the maximum value and the minimum value of the envelope detection signal exceeds a predetermined value.

5. The control method of an optical disc drive according to claim 4, wherein the maximum value and the minimum value of the envelope detection signal are detected during one revolution of the optical disc.

6. The control method of an optical disc drive according to claim 5, wherein the one revolution of the optical disc is determined by detecting a pulse signal generated every one revolution of a spindle motor in rotating the optical disc.

7. The control method of an optical disc drive according to claim 2, wherein the pickup module is controlled to perform the layer jump in a region between two points corresponding to a value that is less than the maximum value of the envelope detection signal by a predetermined value.

8. The control method of an optical disc drive according to claim 2, wherein the pickup module is controlled to perform the layer jump in a region between two points corresponding to a value that is greater than the minimum value of the envelope detection signal by a predetermined value.

9. The control method of an optical disc drive according to claim 1, further comprising:
detecting a point where the relative movement is zero or about zero for a predetermined time period; and
performing the layer jump without taking a deflection of the optical disc into consideration when the point where the relative movement is zero or about zero is not detected during the predetermined time period.

10. A control method of an optical disc drive comprising a pickup module to perform recording and/or reproducing and/or erasing of information by projecting a laser beam on a surface of respective layers of an optical disc having a plurality of layers; and a servo-controller to generate a focus driving signal for the focus servo-control of the pickup module, the method comprising:
rotating the optical disc;
detecting at least one of points relative to the optical disc where optical axial distance between the optical disc and the pickup module is at a maximum or a minimum; and
controlling the pickup module to perform a layer jump in a vicinity of the detected at least one of the points during the rotation of the optical disc.

11. The control method of an optical disc drive according to claim 10, wherein the detecting the at least one of the points where the optical axial distance between the optical disc and the pickup module is at a maximum or a minimum, comprises:
detecting an envelope of the focus driving signal for the focus servo-control of the pickup module; and
determining points where the envelope detection signal is a maximum value or a minimum value as a point where the distance is the maximum or where the distance is the minimum.

12. The control method of an optical disc drive according to claim 11, further comprising determining whether the optical disc is deflected; wherein
when the optical disc is deflected, the pickup module is controlled to perform the layer jump in the vicinity of the at least one of the points where the distance is the maximum or the minimum.

13. The control method of an optical disc drive according to claim 12, wherein in the determining of whether the optical disc is deflected, the optical disc is determined as deflected when a difference between absolute values of the maximum value and the minimum value of the envelope detection signal exceeds a predetermined value.

14. The control method of an optical disc drive according to claim 13, wherein the maximum value and the minimum value of the envelope detection signal are detected during one revolution of the optical disc.

15. The control method of an optical disc drive according to claim 14, wherein the one revolution of the optical disc is determined by detecting a pulse signal generated every one revolution of a spindle motor in rotating the optical disc.

16. The control method of an optical disc drive according to claim 11, wherein the pickup module is controlled to perform the layer jump in a region between two points corresponding to a value that is less than the maximum value of the envelope detection signal by a predetermined value.

17. The control method of an optical disc drive according to claim 11, wherein the pickup module is controlled to perform the layer jump in a region between two points corresponding to a value that is greater than the minimum value of the envelope detection signal by a predetermined value.

18. The control method of an optical disc drive according to claim 10, further comprising:
detecting the at least one of the points relative to the optical disc where the distance is the maximum or the minimum for a predetermined time period; and
performing the layer jump without taking a deflection of the optical disc into consideration when the at least one of the points where the distance is the maximum or the minimum is not detected during the predetermined time period.

19. An optical disc drive comprising:
a pickup module to perform recording and/or reproducing and/or erasing of information by projecting a laser beam on a surface of respective layers of an optical disc having a plurality of layers; and
a servo-controller to control the pickup module to perform a layer jump in a vicinity of any one point where an optical axial relative movement between the optical disc and the pickup module is zero or about zero during a rotation of the optical disc.

20. The optical disc drive according to claim 19, wherein the servo-controller detects an envelope of a focus driving signal of a focus servo-control of the pickup module, and controls the pickup module to perform the layer jump at the any one point in the vicinity of a maximum value or a minimum value of the detected envelope detection signal.

21. An optical disc drive comprising:
a pickup module to perform recording and/or reproducing and/or erasing of information by projecting a laser beam on a surface of respective layers of an optical disc having a plurality of layers; and
a servo-controller to control the pickup module to perform a layer jump in a vicinity of any one point of the points where optical axial distance between the optical disc and the pickup module is a maximum or a minimum during a rotation of the optical disc.

22. The optical disc drive according to claim 21, wherein the servo-controller detects an envelope of a focus driving signal for a focus servo-control of the pickup module, and controls the pickup module to perform the layer jump at the any one point in the vicinity of the maximum value or the minimum value of the detected envelope detection signal.

23. The control method of an optical disc drive according to claim 1, wherein the layer jump is performed by taking a deflection of the optical disc into consideration.

24. The control method of an optical disc drive according to claim 10, wherein the layer jump is performed by taking a deflection of the optical disc into consideration.

25. The optical disc according to claim 19, wherein the layer jump is performed by taking a deflection of the optical disc into consideration.

26. The optical disc drive, according to claim 21, wherein the servo-controller performs the layer jump by taking a deflection of the optical disc into consideration.

27. The control method of an optical disc drive according to claim 1, wherein the detecting of the point where the relative distance is zero or about zero occurs over a predetermine time and so the point is detected when relative speed between the optical disc and the pickup module is zero or about zero.

28. The control method of an optical disc drive according to claim 1, wherein prior to the controlling of the pickup module to perform the layer jump, a tracking servo-control is stopped and only the focus servo-control is performed.

29. A control method of an optical disc drive comprising a pickup module to perform recording and/or reproducing and/or erasing of information by projecting a laser beam on a surface of respective layers of an optical disc having a plurality of layers; and a servo-controller to generate a focus driving signal for the focus servo-control of the pickup module, the method comprising:
rotating the optical disc;
detecting whether the optical disc is deflected when a value of an envelope detection signal of the focus driving signal is greater than or equal to |MAX|−|MIN|, where |MAX| is an absolute maximum value of the envelope detection signal and the |MIN| is an absolute minimum value of the envelope detection signal; and
controlling the pickup module to perform a layer jump during the rotation of the optical disc when the envelope detection signal is at or between a first predetermined value and the MAX, or at or between a second predetermined value and the MIN.

30. The control method of an optical disc drive according to claim 29, wherein the envelope detection signal is a low pass filtered signal of the focus driving signal.

31. The control method of an optical disc drive according to claim 29, wherein the envelope detection signal is at or between a first predetermined value and the MAX, or at or between a second predetermined value and the MIN when the relative movement of the pickup module and the optical disc to each other in the optical axis direction is zero or about zero.

32. The control method of an optical disc drive according to claim 29, wherein the layer jump is performed in a margin between the first predetermined value and the MAX, or a margin between the second predetermined value and the MIN.
